(19) United States
(12) Patent Application Publication
(10) Pub. No.: US 2016/0341277 A1
(43) Pub. Date: Nov. 24, 2016

(54) DYNAMIC HARMONIC BALANCER

(71) Applicant: GM GLOBAL TECHNOLOGY OPERATIONS LLC, Detroit, MI (US)

(72) Inventors: Sean M. McGowan, Northville, MI (US); Eric D. Staley, Flushing, MI (US)

(73) Assignee: GM GLOBAL TECHNOLOGY OPERATIONS LLC, Detroit, MI (US)

(21) Appl. No.: 14/718,468

(22) Filed: May 21, 2015

(51) Int. Cl. F16F 15/36; F02F 1/24; F02F 3/00; F02F 7/00

(52) U.S. Cl. CPC F16F 15/366; F02F 7/0002; F02F 1/24; F02F 3/00; F02F 7/0043

(57) ABSTRACT

A dynamic harmonic balancer for mounting on a crankshaft of an internal combustion engine includes an element defining a cavity. The dynamic harmonic balancer also includes a body of fluid disposed within the cavity. The dynamic harmonic balancer additionally includes a plurality of pellets disposed within the body of fluid and configured to shift within the cavity. The shifting of the pellets within the cavity counteracts an imbalance in the harmonic balancer and damps crankshaft torsional vibrations during operation of the engine. An engine having such a dynamic harmonic balancer is also disclosed.

### TECHNICAL FIELD

The present disclosure relates to a dynamic harmonic balancer for damping out torsional vibrations in a crankshaft of an internal combustion engine.

### BACKGROUND

Generally, a harmonic balancer is a tuned mass damper, a device mounted in structures to reduce the amplitude of mechanical vibrations. In an internal combustion engine, a harmonic balancer is a device fitted to an end of the engine's crankshaft for reducing resonant torsional vibrations that tend to peak at certain crankshaft speeds.

Torsional vibrations can greatly reduce crankshaft life and may even cause instantaneous failure if the crankshaft runs at or through resonance. Because of this, harmonic balancers are designed with a specific weight and diameter to damp crankshaft resonances.

### SUMMARY

A dynamic harmonic balancer for mounting on a crankshaft of an internal combustion engine includes an element defining a cavity. The dynamic harmonic balancer also includes a body of fluid disposed within the cavity. The dynamic harmonic balancer additionally includes a plurality of pellets, such as a steel shot, disposed within the body of fluid and configured to shift within the cavity. The shifting of the pellets within the cavity counteracts an imbalance in the harmonic balancer and damps crankshaft torsional vibrations during operation of the engine.

The dynamic harmonic balancer may additionally include a hub connected to the first end of the crankshaft and an outer ring connected to the hub. The hub may be keyed to an end of the crankshaft.

The outer ring may include an outer surface configured as a pulley for driving an accessory belt.

The outer ring may either be a powder metal forging, a casting, or a machined component.

The element may be an integral part of the outer ring.

The hub and the outer ring may be formed together as a unitary one-piece body. A plug may be used to fluidly seal the cavity inside the element.

The body of fluid may be a first body of fluid and the cavity may be a first cavity. In such a case, the outer ring may define a second cavity and a second body of fluid may be disposed within the second cavity. Also, the element may be arranged inside the second body of fluid and be free to shift within the second cavity relative to the outer ring.

The outer ring may include at least one weld configured to fluidly seal the second cavity.

In a cross-sectional view, the element may include a pair of sidewalls, an outer diameter wall, and an inner diameter wall. At least one of the outer and inner diameter walls may include an inertia mass incorporated therein.

The element may either be a powder metal forging, a casting, or a machined component.

An engine having such a dynamic harmonic balancer is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic perspective view of an internal combustion engine illustrating a dynamic harmonic balancer according to the disclosure.

FIG. 2 is a schematic partially cross-sectional perspective view of the dynamic harmonic balancer shown in FIG. 1 according to one embodiment.

FIG. 3 is a schematic partially cross-sectional perspective view of the dynamic harmonic balancer shown in FIG. 1 according to another embodiment.

FIG. 4 is a schematic enlarged view of the dynamic harmonic balancer shown in FIG. 3.

### DETAILED DESCRIPTION

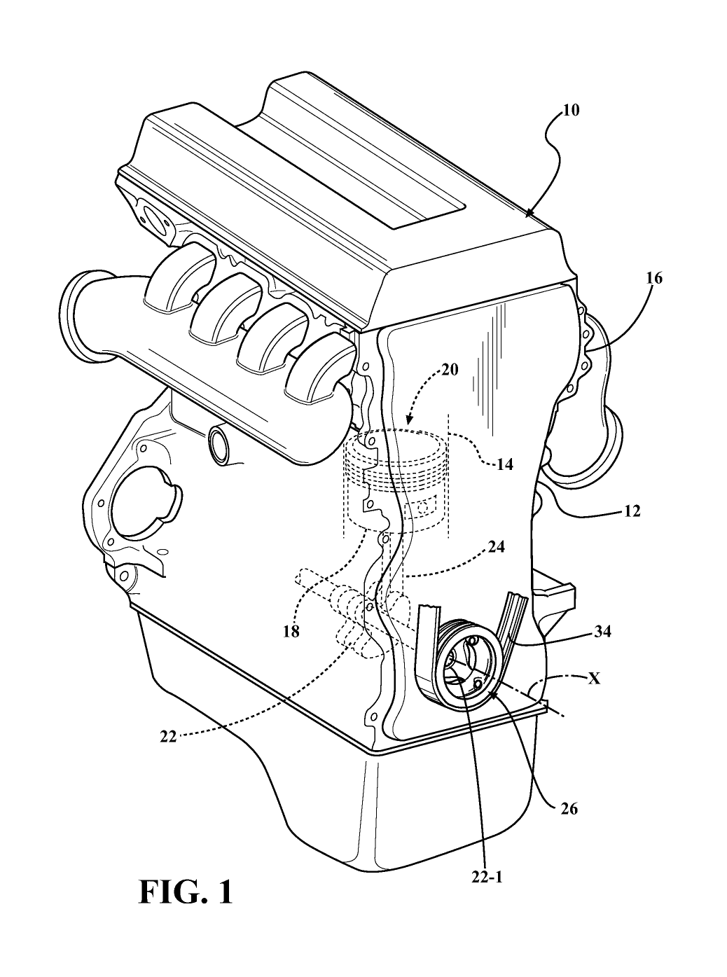

Referring to the drawings, wherein like reference numbers correspond to like or similar components throughout the several figures, FIG. 1 illustrates an internal combustion engine 10, such as a spark- or compression-ignition type, typically used for propulsion of a vehicle (not shown). The engine 10 includes a cylinder block 12 with a plurality of cylinders 14 arranged therein and a cylinder head 16 that is mounted on the cylinder block. The cylinder head 16 receives air and fuel as a pre-combustion charge to be used inside the cylinders 14 for subsequent combustion.

Each cylinder 14 includes a respective piston 18 configured to reciprocate therein. Combustion chambers 20 are formed within the cylinders 14 between the bottom surface of the cylinder head 16 and the tops of the pistons 18. An airflow is directed to each of the combustion chambers 20 where fuel is combined with air and to form a fuel-air mixture for subsequent combustion inside the subject combustion chamber. Although an in-line four-cylinder engine is shown in FIG. 1, nothing precludes the present disclosure from being applied to an engine having a different number and/or arrangement of cylinders. The engine 10 also includes a crankshaft 22 configured to rotate within the cylinder block 12 about an axis X. As known to those skilled in the art, the crankshaft 22 is rotated by the pistons 18 via connecting rods 24 as a result of the cylinders 14 firing, i.e., an appropriately proportioned mixture of fuel and air being combusted in the combustion chambers 20.

During operation of such an internal combustion engine, energy transferred from the pistons can induce as much as 2 degrees of twist in the crankshaft, with the crankshaft essentially acting as an elastic component storing and releasing vibrational energy. Every time the engine's cylinders fire, torque is imparted to the crankshaft. Initially, the crankshaft deflects under such torque, and, when the torque is released, vibrations generally develop in the crankshaft structure. At certain engine speeds the successive torque inputs from the pistons are in sync with the natural frequency of the crankshaft when even small periodic driving forces can produce large amplitude oscillations. Accordingly, when the successive torque inputs from the pistons coincide with the crankshaft's natural frequency, a resonance can be set up in the crankshaft structure. Such resonance can generate sufficient stress in the crankshaft to cause damage thereto. The amplitude or magnitude of forces acting on the crankshaft 22 during its rotation can be reduced by improving the balance of the crankshaft about its rotational axis X. However, a perfect balance of the crankshaft 22 is practically impossible to achieve. Various mechanical harmonic balancers have been employed on internal combustion engines in an effort to counteract any remaining imbalance in the crankshaft and damp out crankshaft torsional vibrations.

As shown, to counteract torque inputs from the pistons 18 at the natural frequency of the crankshaft 22 in the engine 10 and prevent damaging resonance vibration therein, a dynamic harmonic balancer 26 is attached to a first end 22-1 of the crankshaft. The dynamic harmonic balancer 26 includes a hub 28 that is fixedly connected, such as keyed, to the first end 22-1 of the crankshaft 22. The dynamic harmonic balancer 26 also includes an outer ring 30 connected or fixed to the hub 28, such as via spokes or struts 32, thereby resulting in a one-piece hub-outer ring element. The outer ring 30 may either be a powder metal forging, a casting, or a machined metal part. The outer ring 30 includes an outer surface 30-1 configured as a pulley for driving an accessory belt 34. The dynamic harmonic balancer 26 additionally includes an element 36 defining a continuous, 360-degree cavity 38. A body of fluid 40 is disposed within the cavity 38. Additionally, a plurality of dense balls or pellets 42, such as a steel shot, is disposed within the body of fluid 40.

The pellets 42 are submerged within the body of fluid 40 and are free to shift within the cavity 38, being impeded only by the viscosity μ of the subject fluid. The viscosity μ of the body of fluid 40 is specifically selected such that the pellets 42 will impart a significant shear force τ to the fluid and thus generate an appropriate resistance to the movement of the pellets within the cavity 38. Accordingly, the viscosity μ of the body of fluid 40 provides the requisite damping in the response of the dynamic harmonic balancer 26 to vibrations in the crankshaft 22. The shear force τ in the body of fluid 40 is described by the equation τ=μ*[dv/dy], wherein viscosity of the fluid μ is multiplied by the change in velocity per distance dv/dy of the pellets 42. To generate appropriate shear force T via the pellets 42, specially formulated silicone may be selected for the body of fluid 40. Silicone exhibits stable properties across a wide temperature range—typically −40 to 300 degrees Fahrenheit. Additionally, such silicone can be around 45,000 times thicker than 30-weight gear oil and its viscosity μ at extreme operating temperatures likely to be encountered by the engine 10.

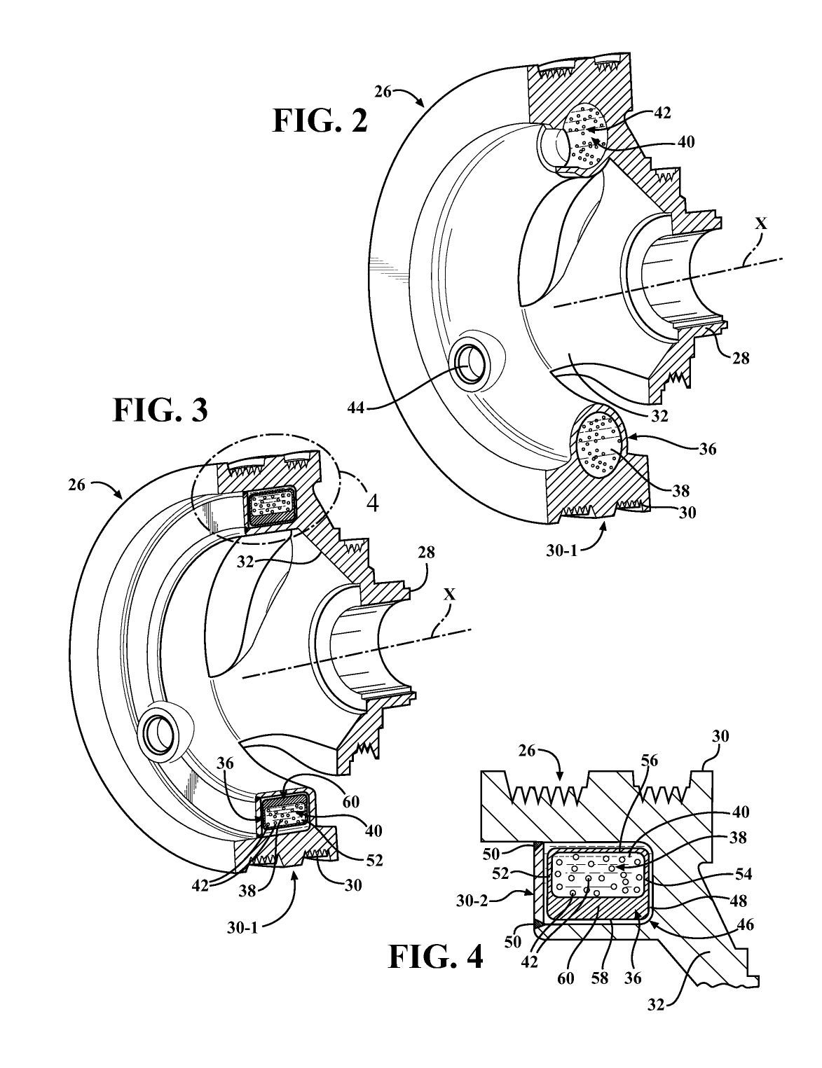

In a first embodiment of the dynamic harmonic balancer 26 shown in FIG. 2, the element 36 is an integral part of, for example cast together with, the outer ring 30. Additionally, in the first embodiment, the hub 28 and the outer ring 30 may be formed together as a unitary, one-piece body. A plurality of plugs 44 may be employed in the subject embodiment to fluidly seal the cavity 38 inside the element 36 subsequent to the body of fluid 40 and the pellets 42 being added into the cavity. The one-piece hub 28 and outer ring 30 may be formed together either as a powder metal forging or a casting. In a second embodiment of the dynamic harmonic balancer 26 shown in FIGS. 3-4, the body of fluid 40 is a first body of fluid and the cavity 38 is a first cavity. Additionally, in the second embodiment, the outer ring 30 defines a second cavity 46, while a second body of fluid 48 is disposed within the second cavity. The element 36 is arranged inside the second body of fluid 48 and is free to shift or rotate within the second cavity 46 relative to the unified hub 28 and outer ring 30 about the axis X.

As shown in FIG. 4 illustrating an enlarged view of the second embodiment of the dynamic harmonic balancer 26, the unified hub 28 and outer ring 30 may include a separate plate 30-2 fixed via weld(s) 50 to the outer ring section. The plate 30-2 is configured to fluidly seal the second cavity 46 via the weld(s) 50 once the element 36 and the second body of fluid 48 have been placed therein. Also, as can be seen in the cross-sectional view 3-3, the element 36 includes a pair of sidewalls 52 and 54, an outer diameter wall 56, and an inner diameter wall 58. The weld 50 may be employed at any of the walls, 52, 54, 56, and 58. In the second embodiment shown in FIGS. 3-4, the element 36 may be formed from powder metal, a forging, or a machined metal part for ease of welding the respective wall(s) via the welds 50. At least one of the walls, 52, 54, 56, and 58 can incorporate an inertia mass 60 such that the subject wall will have a greater thickness than the remaining walls for the purpose of increasing a moment of inertia of the element 36. Such an increased moment of inertia of the element 36 may be especially beneficial to countering and cancelling out some of the vibrations experienced by the crankshaft 22 during operation of the engine 10. Specifically, the inertia mass 60 can be incorporated either into the outer or the inner diameter walls 56, 58.

In each of the embodiments of FIG. 2 and FIGS. 3-4, the shifting of the pellets 42 within the cavity 38 is configured to counteract an imbalance in the dynamic harmonic balancer 26 and damp out torsional vibrations in the crankshaft 22 during operation of the engine 10. As the crankshaft 22 is spun by the pistons 18, the pellets 42 are urged by a vibration set up by a heavy side or imbalance I in the dynamic harmonic balancer 26 to migrate to a position P within the cavity 38. Such migration of the pellets 42 to the position P will dynamically counter and reduce the amplitude of vibrations affecting the crankshaft 22. The first embodiment of the dynamic harmonic balancer 26 may be sufficient for internally balanced engine configurations, such as a straight-six, a 60-degree V6, and the majority of 90-degree V8's. Specifically with respect to the embodiment of the dynamic harmonic balancer 26, the entire element 36 is additionally free to shift relative to the unified outer ring 30 and hub 28 in order to provide an additional inertia mass 60 capable of countering vibrations of the crankshaft 22. Accordingly, the embodiment of FIGS. 3-4 operates as a more complex spring-damper system.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. A dynamic harmonic balancer for mounting on a crankshaft of an internal combustion engine, the dynamic harmonic balancer comprising:
an element defining a cavity;
a body of fluid disposed within the cavity; and
a plurality of pellets disposed within the body of fluid and configured to shift within the cavity and thereby counteract an imbalance in the harmonic balancer and damp crankshaft torsional vibrations during operation of the engine.

2. The dynamic harmonic balancer according to claim 1, further comprising:
a hub connected to a first end of the crankshaft; and
an outer ring connected to the hub.

3. The dynamic harmonic balancer according to claim 2, wherein the outer ring includes an outer surface configured as a pulley for driving an accessory belt.

4. The dynamic harmonic balancer according to claim 2, wherein the outer ring is one of a powder metal forging, a casting, and a machined component.

5. The dynamic harmonic balancer according to claim 2, wherein the element is an integral part of the outer ring.

6. The dynamic harmonic balancer according to claim 5, further comprising a plug, wherein the hub and the outer ring are formed together as a unitary one-piece body and the plug is configured to fluidly seal the cavity inside the element.

7. The dynamic harmonic balancer according to claim 2, wherein:
the body of fluid is a first body of fluid and the cavity is a first cavity;
the outer ring defines a second cavity;
a second body of fluid is disposed within the second cavity; and
the element is arranged inside the second body of fluid and is free to shift within the second cavity relative to the outer ring.

8. The dynamic harmonic balancer according to claim 7, wherein the outer ring includes at least one weld configured to fluidly seal the second cavity.

9. The dynamic harmonic balancer according to claim 7, wherein in a cross-sectional view the element includes a pair of sidewalls, an outer diameter wall, and an inner diameter wall, and wherein at least one of the outer diameter wall and the inner diameter wall includes an inertia mass incorporated therein.

10. The dynamic harmonic balancer according to claim 7, wherein the element is one of a powder metal forging, a casting, and a machined component.

11. An internal combustion engine comprising:
a cylinder block defining a cylinder;
a cylinder head mounted to the cylinder block;
a reciprocating piston configured to compress an air and fuel mixture inside the cylinder and be reciprocated via combustion of the air and fuel mixture;
a crankshaft arranged in the cylinder block and rotated by the piston, wherein the crankshaft has a first end; and
a dynamic harmonic balancer arranged on the first end of the crankshaft;
wherein the dynamic harmonic balancer includes:
an element defining a cavity;
a body of fluid disposed within the cavity; and
a plurality of pellets disposed within the body of fluid and configured to shift within the cavity to counteract an imbalance in the harmonic balancer and damp crankshaft torsional vibrations during operation of the engine.

12. The internal combustion engine according to claim 11, wherein the dynamic harmonic balancer additionally includes a hub connected to the first end of the crankshaft and an outer ring connected to the hub.

13. The internal combustion engine according to claim 12, wherein the outer ring includes an outer surface configured as a pulley for driving an accessory belt.

14. The internal combustion engine according to claim 12, wherein the outer ring is one of a powder metal forging, a casting, and a machined component.

15. The internal combustion engine according to claim 12, wherein the element is an integral part of the outer ring.

16. The internal combustion engine according to claim 15, further comprising a plug, wherein the hub and the outer ring are formed together as a unitary one-piece body and the plug is configured to fluidly seal the cavity inside the element.

17. The internal combustion engine according to claim 12, wherein:
the body of fluid is a first body of fluid and the cavity is a first cavity;
the outer ring defines a second cavity;
a second body of fluid is disposed within the second cavity; and
the element is arranged inside the second body of fluid and is free to shift within the second cavity relative to the outer ring.

18. The internal combustion engine according to claim 17, wherein the outer ring includes at least one weld configured to fluidly seal the second cavity.

19. The internal combustion engine according to claim 17, wherein in a cross-sectional view the element includes a pair of sidewalls, an outer diameter wall, and an inner diameter wall, and wherein at least one of the outer diameter wall and the inner diameter wall includes an inertia mass incorporated therein.

20. The internal combustion engine according to claim 17, wherein the element is one of a powder metal forging, a casting, and a machined component.
